(19) United States
(12) Patent Application Publication
(10) Pub. No.: US 2026/0370088 A1
(43) Pub. Date: Nov. 19, 2026

(54) Dynamo Power AC Generator

(71) Applicant: Reginald Keith Sapp, Clinton, MD (US)

(72) Inventor: Reginald Keith Sapp, Clinton, MD (US)

(21) Appl. No.: 19/731,051

(22) Filed: Jul. 4, 2026

(51) Int. Cl. H02K 7/075

(52) U.S. Cl. CPC H02K 7/075

(57) ABSTRACT

A DC alternator FIG. 1A becomes an AC generator from car parts with it reconfigured for its output. The engine FIG. 1B drives the DC alternator by gas all and its purpose is for AC power with the help of the camshaft FIG. 1C.

### CROSS-REFERENCE TO RELATED APPLICATION

Non-Applicable

### STATEMENT REGARDING FEDERAL SPONSORED RESEARCH OR DEVELOPMENT

Non-Applicable

### BACKGROUND OF INVENTION

### Field of the Invention

To produce AC electric energy by using a car engine

### Description of Related Art

A car 2753 cc inline cylinder 5,200 rpm Horse Power 4 stroke car engine Toyota or Nissan engine.

### BRIEF SUMMARY OF THE INVENTION

The engines power the AC redesigned Alternator to a AC Generator. That will output 120 VAC power.

### BRIEF DESCRIPTION OF THE SEVERAL VIEWS OF THE DRAWINGS

FIG. 1A An Alternator turn into a Generator

FIG. 1B A 4 to 6 gas or diesel Cylinder engine

FIG. 1C The Camshaft that turns the generator

### BRIEF SUMMARY OF THE INVENTION

The engine is gas or diesel powered that turns the converted Alternator to a Generator.

### DETAILED DESCRIPTION OF THE INVENTION

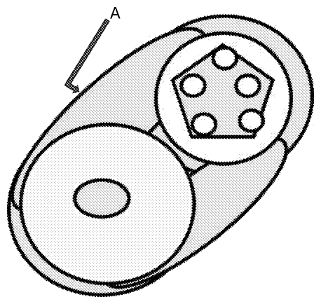

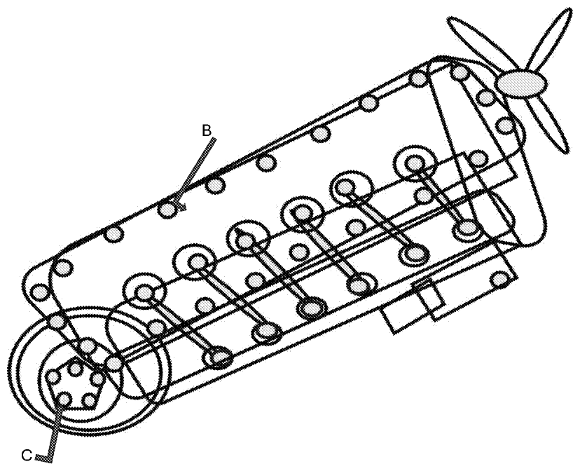

This device is made from a 280ZX 4 to 6 2753 cc inline cylinder 5,200 rpm Horse Power 4 stroke car engine FIG. 1B and its alternator FIG. 1A. The model is to be housed and configured for a mechanical attachment to the crankshaft FIG. 1C.

It works on the Mechanical application of a 280ZX sport car gas driven manual transmission four to six straight block engine powered FIG. 1B which connected with a generator Fig A. The gas can be unleaded or diesel.

The crankshaft FIG. 1C turns the generator at a RPM(Revolution Per Minuet). This output is an AC voltage, Amps and Power to energize electrical build circuits for all application that uses AC power.

A test was made with a 1980 to 1984 280zx six cylinder engine FIG. 1B. The alternator of the vehicle was converted from DC volts to AC Volts by reconfiguring the Alternator design which remodifies the alternator.

1. We found by taking an alternator from an engine reconfiguring its structure to output a high amp. This allows for electrical power to be outputted at a high volt and high amp. We set gauges up to measure the output current of the alternator which is able to power private homes, constructions, and community buildings, stadium and more.
We founded that the configuration is simple to build a stronger alternator and to build the engine or the rebuild an engine from used parts.
